(19) United States
(12) Patent Application Publication
(10) Pub. No.: US 2024/0184621 A1
(43) Pub. Date: Jun. 6, 2024

(54) Firmware Apparatus, Device, Method and Computer Program

(71) Applicant: Intel Corporation, Santa Clara, CA (US)

(72) Inventors: Sarathy JAYAKUMAR, Portland, OR (US); Zijian YOU, Shanghai (CN); Karthik GOPALAKRISHNAN, Folsom, CA (US); Erik KANEDA, Hood River, OR (US); Dan WILLIAMS, Forest Grove, OR (US)

(21) Appl. No.: 18/570,132

(22) PCT Filed: Dec. 9, 2021
(86) PCT No.: PCT/CN2021/136645

§ 371 Date: Dec. 14, 2023

(51) Int. Cl. G06F 9/48; G06F 9/52

(52) U.S. Cl. CPC G06F 9/485; G06F 9/4825; G06F 9/52

(57) ABSTRACT

Various examples relate to a firmware apparatus (10), firmware device, firmware method, and computer program for a computer system (100) comprising processing circuitry (105), and to a corresponding computer system (100). The firmware apparatus (10) comprises an interface (12) for accessing functionality of the firmware apparatus (10) from an operating system of the computer system (100). The firmware apparatus (10) comprises control circuitry (14), configured to identify one or more processing functionalities being supported by the processing circuitry (105) of the computer system (100), provide information on the one or more processing functionalities via the interface (12) to a user mode interface of the operating system of the computer system (100), and provide access to the one or more processing functionalities for application programs being executed in the operation system, the access being based on the information on the one or more processing functionalities provided to the user mode interface.

### BACKGROUND

The computer industry frequently introduces new features and enhances performance of existing features through the means of new instructions such as Streaming Single Instruction Multiple Data Extensions (SSE), Advanced Vector extensions (ACX), PCommit (an instruction to commit data writes queued in memory subsystem to persistent memory/storage), etc.) or new architecture designs for CPUs (Central Processing Units), GPUs (Graphics Processing Units), AS<ICs (Application-Specific Integrated Circuits), FPGAs (Field-Programmable Gate Arrays etc.

### BRIEF DESCRIPTION OF THE FIGURES

Some examples of apparatuses and/or methods will be described in the following by way of example only, and with reference to the accompanying figures, in which

FIG. 1a shows a block diagram of an example of a basic input/output system apparatus or device, and of a computer system comprising such a basic input/output system apparatus or device

FIGS. 1b and 1c show flow charts of examples of a basic input/output system method;

FIG. 1d shows a schematic diagram of an example illustrating different components of the computer system;

FIG. 2 shows a schematic diagram of an example of a PRM Architecture with a PRM Handler;

FIG. 3a shows an example of a process for enabling a new instruction;

FIG. 3b shows an example of an enhanced process for enabling a new instruction;

FIG. 4a shows a schematic diagram of a process for enabling a new system function;

FIG. 4b shows a schematic diagram of an enhanced process for enabling a new system function;

FIG. 5a shows a schematic diagram of an example of a process for enabling new graphics hardware; and

FIG. 5b shows a schematic diagram of an example of an enhanced process for enabling new graphics hardware.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

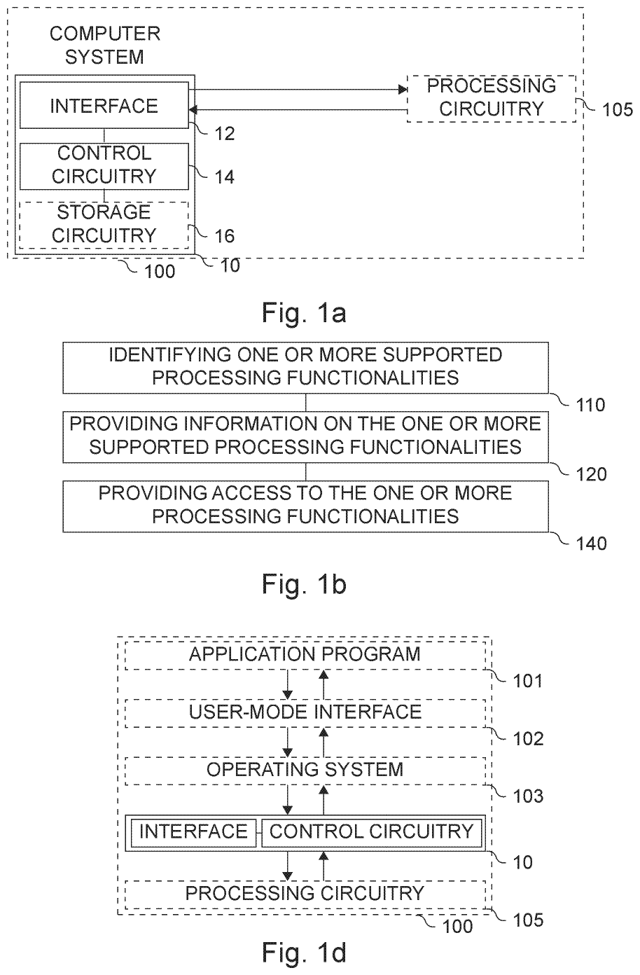

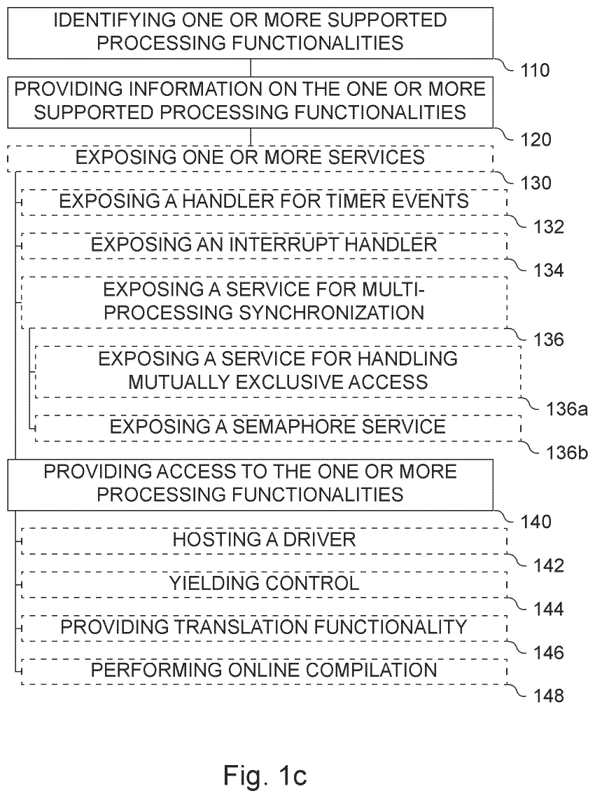

FIG. 1a shows a block diagram of an example of a basic input/output system (firmware) apparatus 10 or device 100, and of a computer system 100 comprising such a firmware apparatus 10 or firmware device 10. As shown in FIG. 1a, the computer system further comprises processing circuitry 105.

The firmware apparatus 10 comprises circuitry that is configured to provide the functionality of the firmware apparatus 10. For example, the firmware apparatus 10 comprises an interface 12, processing circuitry 14 and (optional) storage circuitry 16. For example, the processing circuitry 14 may be coupled with the interface 12 and with the storage circuitry 16. For example, the processing circuitry 14 may be configured to provide the functionality of the firmware apparatus (10), in conjunction with the interface 12 (for exchanging information, e.g., with an operating system, an application and/or processing circuitry 105 of the computer system 100) and the storage circuitry (for storing information) 16. In particular, the interface 12 is suitable for accessing functionality of the firmware apparatus from an operating system of the computer system. Likewise, the firmware device 10 may comprise means that is/are configured to provide the functionality of the firmware device 10. The components of the firmware device 10 are defined as component means, which may correspond to, or implemented by, the respective structural components of the firmware apparatus 10. For example, the firmware device 10 comprises means for controlling 14, which may correspond to or be implemented by the processing circuitry 14, means for communicating 12, which may correspond to or be implemented by the interface 12, and (optional) means for storing information 16, which may correspond to or be implemented by the storage circuitry 16.

The control circuitry 14 or means for controlling 14 is configured to identify one or more processing functionalities being supported by the processing circuitry of the computer system. The control circuitry 14 or means for controlling 14 is configured to provide information on the one or more processing functionalities via the interface to a user mode interface of the operating system of the computer system. The control circuitry 14 or means for controlling 14 is configured to provide access to the one or more processing functionalities for application programs being executed in the operation system. The access is based on the information on the one or more processing functionalities provided to the user mode interface.

FIGS. 1b and 1c show flow charts of examples of a corresponding firmware method for a firmware 10 (e.g., the firmware apparatus or device 10) the computer system 100. The firmware method comprises identifying 110 the one or more processing functionalities being supported by the processing circuitry of the computer system. The firmware method comprises providing 120 the information on the one or more processing functionalities, via the interface for accessing functionality of the firmware 10 from the operating system of the computer system to the user mode interface of the operating system of the computer system. The firmware method comprises providing 140 access to the one or more processing functionalities for application programs being executed in the operation system. The access is based on the information on the one or more processing functionalities provided to the user mode interface. For example, the method may be performed by the computer system 100, e.g., by the firmware (apparatus or device) 10 of the computer system.

In the following, the functionality of the firmware apparatus 10, the firmware device 10, the firmware method and of a corresponding computer program is introduced in connection with the apparatus 10. Features introduced in connection with the firmware apparatus 10 may be likewise included in the corresponding device 10, method and computer program.

Various examples of the present disclosure relate to a firmware apparatus, firmware device, firmware method and corresponding computer program. In general, the firmware being referred to is the firmware of the computer system 100, e.g., the Basic Input Output System (BIOS) or Unified Extensible Firmware Interface (UEFI) of the computer system. The above-referenced firmware apparatus or device may correspond to the firmware, or at least to a component of the firmware. Accordingly, the method may be performed by the firmware or by a component of the firmware. In other words, the firmware apparatus may be implemented as component of the firmware of the computer system, e.g., as component of the basic input output system or the unified extensible firmware interface of the computer system. In this context, the term firmware is used for a class of software that is used to control the hardware of the computer system, acting as interface between the hardware of the computer system and an operating system of the computer system. In general, the firmware of the computer system may be immutable during operation and may be changed by “flashing” (i.e., replacing the firmware by overwriting a flash storage or boot image) the firmware of the computer system. For example, the firmware apparatus or device may be implemented as part of, or extend, the Platform Runtime Mechanism (PRM) being implemented in the BIOS/UEFI of some computer system. For example, the proposed concept may extend the PRM beyond management functionality, providing access to capabilities of the processing circuitry of the computer system.

The proposed concept is used to provide access to processing functionalities provided by processing circuitry of the computer system. In general, the processing circuitry may be any processing circuitry of the computer system. For example, the processing circuitry may be or comprise one or more Central Processing Units (CPUs) and/or one or more Graphics Processing Units (GPUs) of the computer system. Other types of processing circuitry may be supported as well, such as accelerator circuitry, such as accelerator circuitry for accelerating machine-learning processes, a Field-Programmable Gate Array (FPGA) or an Application Specific Integrated Circuit (ASIC). In other words, the processing circuitry may be accelerator circuitry, an FPGA, or an ASIC. Correspondingly, the one or more processing functionalities may correspond to functionalities that are provided by the respective processing circuitry. For example, the one or more processing functionalities may be functionalities that relate to the processing of data. For example, with respect to a CPU or GPU, the one or more processing functionalities may be one or more processor instructions or graphics processing instructions being provided by an instruction set of the CPU or GPU. With respect to an FPGA, the one or more processor instructions may be one or more instructions for loading and applying a configuration of the FPGA. More generally, the one or more processing functionalities may be one or more processing instructions that are supported by the processing circuitry. In general, these one or more processing functionalities or one or more processing instructions may be invoked by corresponding opcodes (operation codes). In the present scenario it is assumed, that the one or more processing functionalities are only recently introduced by the hardware manufacturer providing the processing circuitry. Therefore, software being built to run on the computer system might be compiled using a compiler that is not yet updated to support the one or more processing functionalities.

Initially, the control circuitry is configured to identify the one or more processing functionalities being supported by the processing circuitry of the computer system. In general, the firmware, e.g. the BIOS or UEFI, may be aware of the capabilities of the processing circuitry, e.g., to be compatible with the processing circuitry. For example, the firmware may be updated to support the processing circuitry. After identifying the type/model of the circuitry, information on the one or more processing functionalities of the processing may be retrieved from a storage of the firmware circuitry, e.g. from a storage device 16 of the storage circuitry, to identify the one or more processing functionalities being supported by the processing circuitry of the computer system. Alternatively or additionally, the control circuitry may be configured to obtain the information on the one or more processing functionalities from the processing circuitry. For example, the control circuitry may be configured to query the processing circuitry to indicate, for each of a plurality of processing functionalities, whether the processing functionality is supported by the processing circuitry. For example, the plurality of processing functionalities may depend on the type of processing circuitry, e.g., depend on whether the processing circuitry is/comprises a CPU, GPU, FPGA etc. For example, the one or more processing functionalities being supported may be processing functionalities that are introduced in a current or recently (e.g., one previous to the current) generation of the processing circuitry.

The information on the one or more processing functionalities is provided to a user-mode interface of the operating system of the computer system. This user-mode interface is accessible to application programs being executed as part of the operating system, and thus provides an interface between the application programs and the firmware apparatus (via the interface 12 of the firmware apparatus). The firmware apparatus, in turn, provides access to the one or more processing functionalities of the processing circuitry. Consequently, the application programs may access the one or more processing functionalities via the user-mode interface and the firmware apparatus. The proposed layer stack is shown in FIG. 1d. FIG. 1d shows a schematic diagram of an example illustrating different components of the computer system. An application program 101 access the user-mode interface 102 that is provided by the operating system 103 (albeit in user mode). The user-mode interface 102 communicated, via the operating system 103, with the interface of the firmware apparatus 10. The interface 12 of the firmware apparatus is coupled with the control circuitry of the firmware apparatus 14, which provides access to the one or more processing functionalities of the processing circuitry 105, thus providing access to the one or more processing functionalities of the processing circuitry 105 for the application program 101 via the user-mode interface 102, the operating system 103 and the interface of the firmware apparatus 10. The entire layer stack is comprised by the computer system 100.

The application program 101 directly interacts with the user-mode interface 102. This user-mode interface 102 operates, as the name indicates, in user mode (and thus in a user space portion of virtual memory). In other words, the user mode interface may be provided to the application programs in user mode. Accordingly, the application program 101 can access the one or more processing functionalities of the processing circuitry 105 without switching to kernel mode. For example, the user mode interface may be implemented as a library or application programming interface (API) that may be accessed by the application programs, e.g., by name of the processing functionality. Accordingly, the user mode interface may be implemented as a library that is accessible to the application programs in user space. The control circuitry is configured to provide the information on the one or more processing functionalities via the interface to the user mode interface of the operating system of the computer system. For example, the user mode interface may expose the information on the one or more processing functionalities towards the application programs, e.g., as listing of supported one or more processing functionalities. The control circuitry may provide a listing of the one or more supported functionalities to the user mode interface. The application programs may invoke the one or more processing functionalities based on the provided information on the one or more processing functionalities, e.g., by calling the desired processing functionality by name or reference provided by the user mode interface.

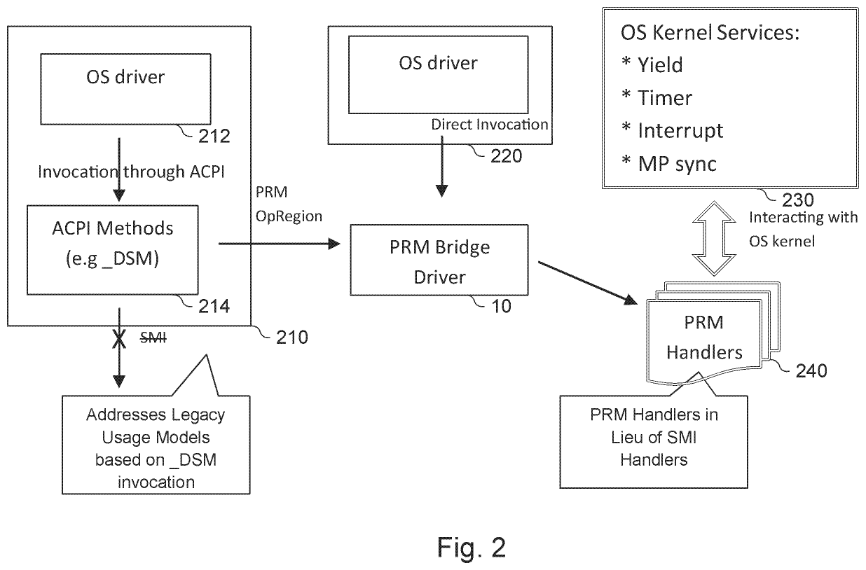

The user mode interface interacts with the interface 12 of the firmware apparatus, which is an interface that is suitable for accessing functionality of the firmware apparatus from the operating system, and thus also from the user mode interface, of the computer system. For example, the interface 12 may be a logical interface, e.g., an API or software interface for interacting with the firmware apparatus. In some examples, as will be shown in connection with FIG. 2, the interface 12 may provide two interfaces—a first interface for communicating with the user mode interface hosted by the operating system, and a second interface for accessing the one or more processing functionalities via the advanced configuration and power interface (ACPI) of the computer system. For example, the second interface may expose the one or more processing functionalities as (so-called) ACPI methods towards the operating system.

The control circuitry is configured to provide access to the one or more processing functionalities for the application programs being executed in the operation system, with the access being based on the information on the one or more processing functionalities provided to the user mode interface. This access may be provided to speed up the software enabling process, so that the processing functionality can be used even before the compilers being used to compile the application programs are updated to support the one or more processing functionalities. Instead, the respective processing functionality can be called via the user mode interface without requiring an update of the compiler.

The firmware apparatus acts as an intermediary between the application programs and the processing circuitry. In particular, the firmware apparatus may provide driver functionality for accessing the processing functionality of the processing circuitry. In other words, the control circuitry may be configured to host (e.g., execute) a driver for accessing the one or more processing functionalities. Accordingly, as shown in FIG. 1c, the method may comprise hosting 142 a driver for accessing the one or more processing functionalities. In other words, a low-level driver may be provided for accessing the processing functionality, e.g., without requiring a driver being hosted by the operating system, e.g., in combination with a processing functionality-agnostic driver that provides access to the processing functionality provided by the firmware apparatus without having logic for driving the respective functionality. The driver hosted by the firmware apparatus may be used to translate between instructions received via the user mode interface (and via the interface of the firmware apparatus) and corresponding instructions expected by the processing circuitry. The access to the one or more processing functionalities may be provided via a processing functionality-agnostic driver hosted by the operating system. In other words, the actual driver functionality may be hosted by the bios apparatus, with the processing functionality-agnostic driver being used to access the interface of the firmware apparatus from the user mode interface.

As outlined above, the interface 12 may provide two interfaces—the first interface for communicating with the user mode interface hosted by the operating system, and the second interface for accessing the one or more processing functionalities via the ACPI of the computer system. While instructions that are received via the first interface are received according to the format imposed by the user mode interface, instructions that are received via the second interface adhere to the format imposed by the ACPI. In particular, so-called “ACPI methods” may be defined that can be used to access the one or more processing functionalities. The control circuitry may be configured to provide access to the one or more processing functionalities via one or more ACPI methods exposed towards the operating system. In this case, providing the information on the one or more processing functionalities may comprise exposing the one or more processing functionalities as ACPI methods towards the operating system.

As outlined above, the firmware apparatus or device may be implemented as part of, or extend, the Platform Runtime Mechanism (PRM) being implemented in the BIOS/UEFI of some computer system. Compared to the initial release of the PRM, the proposed concept may provide a deeper integration of the firmware apparatus with the operating system, providing some co-called services to integrate the operation of the firmware apparatus in the operation of the operating system.

For example, the control circuitry may be configured to expose one or more services towards the operating system via the interface. Accordingly, the method may comprises exposing 130 one or more services towards the operating system via the interface. These services are generally not directly related to the respective processing functionalities being supported by the processing circuitry, but more related to the integration of the firmware apparatus with the operating system. For example, the one or more services may be accessed by the operating system instead of the application programs being executed by the operating system. For example, the one or more services may interact with at least one of one or more system calls, one or more system events and one or more interrupts being managed by the operating system. While different operating systems use different operating system-specific services, these services may be similar across the operating systems. Therefore, the firmware apparatus may provide the services in an operating system-agnostic manner (i.e., in a manner that is compatible with multiple operating systems), and translate the operating system-specific service calls (i.e., service calls that are specific to the operating system currently being executed by the computer system) to operating system-agnostic service calls (i.e., service calls that are not specific to the operating system currently being executed by the computer system and suitable for the services provides by the firmware apparatus), and vice versa. In other words, the one or more services may be implemented in an operating system-agnostic manner. The control circuitry is configured to provide an operating system-specific translation functionality to translate native operating system-specific service calls to operating system-agnostic service calls (and vice versa). Accordingly, as shown in FIG. 1c, the method may comprise providing 146 an operating system-specific translation functionality to translate native operating system-specific service calls to operating system-agnostic service calls. In other words, the control circuitry may be configured to translate the translate native operating system-specific service calls to operating system-agnostic service calls (and vice versa).

A first example of a service to be exposed towards the operating system relates to the reaction to timer events. Handlers may be provided for reacting to timer events generated by the operating system, such that a processing functionality is invoked in response to a timer event. For example, the control circuitry may be configured to expose at least one handler for timer events towards the operating system. Accordingly, the method may comprise exposing 132 at least one handler for timer events towards the operating system. The at least one handler for timer events may be set to trigger at least one processing functionality. In other words, when a timer event occurs (e.g., is generated/thrown by the operating system), a handler that is associated with the timer event is invoked, thereby triggering the corresponding processing functionality.

Another example of a service relates to interrupt handlers. As the name indicates, interrupt handlers are used to handle interrupts, e.g., hardware interrupts, software interrupt instructions or exceptions, which are events that are generated (i.e., “thrown”) by hardware devices (such as the processing circuitry) or software (such as a driver of the processing circuitry, an application program, or the operating system). The control circuitry may be configured to expose at least one interrupt handler towards the operating system. Accordingly, the method may comprise exposing 134 at least one interrupt handler towards the operating system. The at least interrupt handler may be set to trigger at least one processing functionality. In other words, when an interrupt is generated (i.e., thrown), e.g., by the hardware device or by software, that is handled by the at least one interrupt handler, the corresponding processing functionality may be triggered in response to the interrupt.

A third type of services relates to multi-processing synchronization, and in particular multiprocessing access to the one or more processing functionalities of the processing circuitry. The control circuitry may be configured to expose at least one service for multi-processing synchronization to the operating system. Accordingly, the method may comprise exposing 136 at least one service for multi-processing synchronization to the operating system. The at last one service for multi-processing synchronization may be suitable for, or configured to, restricting/restrict access to the one or more processing functionalities with respect to multiple concurrent attempts to access the one or more processing functionalities. For example, the firmware apparatus may provide at least one of the two following services for multiprocessing synchronization: mutex (mutually exclusive access) and semaphore. Mutex and semaphore generally are kernel resources that provide multi-processing synchronization services. In the proposed concept, with respect to the one or more processing functionalities of the processing circuitry, the firmware apparatus may handle the mutex and semaphore in place of, or in cooperation with, the kernel of the operating system. For example, the control circuitry may be configured to expose at least one service for handling mutually exclusive (mutex) access to the one or more processing functionalities to the operating system. Accordingly, the method may comprise exposing 136a at least one service for handling mutually exclusive access to the one or more processing functionalities to the operating system. For example, the at least one service for handling mutually exclusive to the one or more processing functionalities may restrict access to the respective processing functionality to a single access, e.g., to a single application program or thread of an application program at the same time. The single application program may be provided with a token (a mutex) to access the respective processing functionality until the application program gives back the token to the operating system. Another service relates to semaphores. The control circuitry may be configured to expose at least one semaphore service for synchronizing access to the one or more processing functionalities to the operating system. Accordingly, the method may comprise exposing 136b at least one semaphore service for synchronizing access to the one or more processing functionalities to the operating system. A semaphore is a more general version of a mutually exclusive access. Semaphores are used to signal a state of multiple processes accessing a shared resource between the multiple processes. The semaphore service may be used to create, alter or query at least one semaphore being handled by the firmware apparatus (relating to the one or more processing functionalities), and to notify one or more application programs when the semaphore is altered (e.g., to trigger a component of the application program).

While the one or more processing functionalities may generally relate to atomic operations, some of the operations may require some time to complete. For example, if a processing functionality relates to loading an image into a FPGA, or to computing one training iteration of a neural network, the time required for completing the respective task may be immense, e.g., multiple seconds or even minutes. To avoid stalling the CPU of the computer system, the control of the CPU may be handed back to the operating system after the respective processing functionality is triggered. In other words, the firmware apparatus may yield control of the CPU back to the operating system, e.g., to a scheduler of the operating system. For example, the control circuitry may be configured to yield control (e.g., of the CPU) to the operating system while waiting for the execution of a processing functionality to complete. Accordingly, the method may comprise yielding 144 control to the operating system while waiting for the execution of a processing functionality to complete.

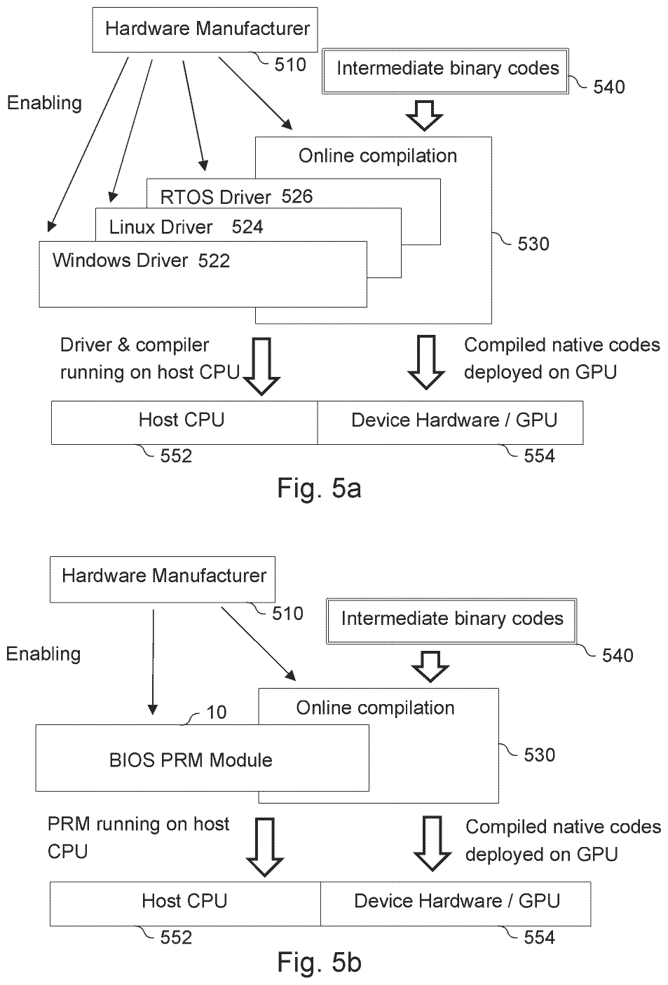

As will be further illustrated in connection with FIGS. 5a and 5b, in some scenarios, the proposed concept may be used to adapt device-independent binary code (so-called “intermediate binary code”) to device-specific binary code. The process is denoted “online compilations”, as it is being performed at runtime (“online”) instead of at the time the code is compiled by the developer (“offline”). The control circuitry may be configured to perform online compilation of a device-independent intermediate binary code (i.e., the intermediate code) of the application programs to device-specific code for accessing the one or more processing functionalities. Accordingly, as shown in FIG. 1c, the method may comprise performing 148 online compilation of a device-independent intermediate binary code of the application programs to device-specific code for accessing the one or more processing functionalities. As indicated above, online compilation is a (cross-)compilation that is being performed at runtime.

The interface 12 or means for communicating 12 of FIG. 1a may correspond to one or more inputs and/or outputs for receiving and/or transmitting information, which may be in digital (bit) values according to a specified code, within a module, between modules or between modules of different entities. For example, the interface 12 or means for communicating 12 may comprise interface circuitry configured to receive and/or transmit information.

For example, the control circuitry 14 or means for controlling 14 of FIG. 1a may be implemented using one or more processing units, one or more processing devices, any means for controlling/processing, such as a processor, a computer or a programmable hardware component being operable with accordingly adapted software. In other words, the described function of the processing circuitry 14 or means for controlling may as well be implemented in firmware/software, which is then executed on one or more programmable hardware components. Such hardware components may comprise a general purpose processor, a Digital Signal Processor (DSP), a micro-controller, etc. In some cases, e.g., if the processing circuitry is a CPU of the computer system, the control circuitry may be implemented by the CPU, e.g., via firmware instructions being executed on the CPU.

For example, the storage circuitry 16 or means for storing information 16 of FIG. 1a may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the firmware apparatus 10, firmware device 10, firmware method, computer program, processing circuitry 105 and computer system 100 are mentioned in connection with the proposed concept or one or more examples described above or below (e.g. FIGS. 2 to 5b). The firmware apparatus 10, firmware device 10, firmware method, computer program, processing circuitry 105 and computer system 100 may comprise one or more additional optional features corresponding to one or more aspects of the proposed concept or one or more examples described above or below.

Various examples of the present disclosure relate to an Operating System (OS) agnostic abstraction for computing architecture.

For new hardware innovations, some hardware manufacturers drive the initiative of unified Application Programming Interfaces (APIs) for cross-architecture development, e.g., to simplify the software ecosystem enabling process. The proposed concept aims at further simplifying the ecosystem enabling process by removing operating system (OS) dependency by moving functions into a Sub-Zero API exposed by the BIOS (Basic Input/Output System). In the following, the proposed concept is shown in connection with the Platform Runtime Mechanism (PRM). However, the features shown in connection with the PRM may be applied to any BIOS apparatus or device, e.g., to the BIOS apparatus or device shown in connection with FIGS. 1a to 1d.

In other systems, an enabling process may be as follows. First, the compiler may be upgraded to emit new instructions. This involves upgrading compilers for different targeted OS's such as Linux and Microsoft Windows. Second, OS drivers may be developed or updated to encapsulate the new architectural changes and interface with applications. For GPU and ASICs, a new or upgraded device driver may be developed to abstract the architectures. For FPGAs, a new or upgraded device driver may be developed to load FPGA binaries. As a third task, an online compiler for the intermediate binary codes (e.g., SPIR-V) for computational tasks may be updated. These intermediate binary codes may be designed such that developers do not have to recompile an algorithm for new hardware architecture. The online compiler may translate intermediate codes into device specific codes at OS runtime. For example, such methods are widely used in various software tools and APIs, e.g., in compilers such as MSVC (Microsoft Visual C++ compiler), GCC (GNU Compiler Collection), ICC (Intel® C Compiler) and LLVM (Low-Level Virtual Machine), and in APIs such as OpenGL (Open Graphics Language), OpenCL (Open Computation Language), CUDA (Compute Unified Device Architecture), IntelX OneAPI etc.

However, the above method involves some effort in OS-specific development, be it on compilers (offline compiler and online compiler) or on device drivers. Since developers often use different OS's (e.g., different versions of Linux and Windows), these may lead to multiplied development and validation costs for OS types and versions, delayed time to market, and increased complexities in deployment and sustaining.

To address the above deficiencies, the proposed concept proposes a concept that uses the runtime BIOS infrastructure to host these new instructions and architectures. The proposed concept may remove OS dependency, avoid duplicated OS specific works, which may lead to simplified enabling, deployment and sustaining for hardware innovations. The proposed concept proposes to enhance a current form of OS/BIOS interface—PRM (Platform Runtime Mechanism) to achieve this.

PRM is a feature to be integrated in the BIOS or UEFI (Unified Extensible Firmware Interface), which seeks to supplant some functionality that previously has been provided by the System Management Mode (SMM) that is used in computer systems. With the proposed concept, PRM can be enhanced to strengthen cross-platform APIs, such as IntelX's OneAPI with its OS neutrality as an advantage over competitors' offerings.

The proposed concept may address some shortcomings of existing OS dependent solutions by using an OS-agnostic runtime BIOS infrastructure to host hardware architecture innovations.

PRM is a newly designed infrastructure across BIOS and OS that allows BIOS modules to run in OS kernel space. These BIOS modules provide runtime support for the OS through a clearly defined interface while the BIOS modules themselves are OS agnostic.

PRM is primarily designed to replace traditional BIOS runtime functions in SMM. This proposed concept focuses on enhancing PRM's OS/BIOS interface to allow compliant BIOS modules to interact more closely with OS. With this enhancement, PRM becomes suitable to host more complex architectural features which are traditionally hosted by OS drivers.

This may reduce the cost of enabling and bringing to market new hardware features, avoiding duplicated efforts to enable OS's of different types and versions. When applicable, it may remove the dependency on compiler updates, which in many cases are out of control of the hardware manufacturer. Also, it may provide a simplified and flexible usage model, where features are shipped with the BIOS on the platform. User can query and use the features, either directly from bare metal (through the UEFI interface) or within a selected OS. It may also simplify sustaining (i.e., maintaining), as it may lead to fewer software patches (in PRM form), without the multiplications in OS types and versions.

Moreover, the BIOS travels with the platform and is customized for the given Silicon and Platform. Taking PCOMMIT (now deprecated) as an example. PCOMMIT was ISA (Instruction Set Architecture)-based in one generation, Targeted PCOMMIT (ucore (microcore)/BIOS based/non-ISA) in the next generation, and possibly something else (like ondemand eADR (extended Asynchronous DRAM (Dynamic Random Access Memory) Refresh) in a future generation. These generational improvements for the same feature may result in OS eco-system enabling challenges, while also leading to effort to maintain backward compatibility since the same OS can be installed on multiple generations of Silicon. Since the BIOS is customized for every platform and travels with the platform, it can exercise the sequence that is appropriate/efficient for the given SoC/Platform to achieve the desired end-result. This approach is also OS agnostic and alleviates the need to enable the OS eco-system for every generational improvement (for the same feature) and maintain backward compatibility.

PRM may be considered to be motivated by the need to reduce the SMM footprint by providing a mechanism to invoke native code execution context from ACPI (Advanced Configuration and Power Interface, instead of dropping into SMI (System Management Interrupt) to achieve the same). PRM is executed in Ring-0. This proposed concept can be thought of as an extension to that PRM concept, where the need for ring transitions is alleviated by making this a Ring-3 layer, i.e., by providing an interface in Ring-3. The proposed concept may provide an OS-agnostic user mode library, customized for a given platform and carried and delivered by the platform itself (instead of having to enable the whole ecosystem every generation and maintain backward compatibility).

Since BIOS travels with the platform, ISA opcodes (operation codes) may be hand-edited without the need to update the compiler and can be deployed with lesser hurdles. If there are non-architectural sequences that would make it efficient to enable the same feature, these sequences may be placed in the BIOS (or any other platform entity).

A hardware platform that uses the proposed concept may provide a BIOS runtime interface that integrates more tightly with OS than an initial PRM interface and expose a runtime firmware interface not only for traditional BIOS system management works, but also for new instructions and heterogenous computing. The OS may cooperate with the BIOS to perform functional/computational tasks beyond the scope of traditional system management work, and the OS/BIOS interaction may go through the interfaces provided by the proposed concept.

In the following, examples are given for the design of the OS/BIOS interface.

The PRM (Platform Runtime Mechanism) was initially designed to move BIOS runtime functions from SMM to OS kernel space. It can be used to provide the system hardware management tasks such as RAS (Reliability, Accessibility and Serviceability) and CPU power management. These tasks are time efficient (in the range of milli-seconds) and can be done atomically without interactions with OS. In this regard, the initial PRM is designed with needing minimal OS services.

For PRM to host more lengthy and complex tasks, such as loading binary into FPGA, or running computing tasks (e.g., image rendering, DNN (Deconvolutional Neural Network) inference) with GPU, a deeper interaction with OS on thread scheduling may be desired. For this purpose, one or more of the following OS services may be abstracted and provided to PRM:

For example, in terms of execution control, timer callback registration may be provided. These services allow PRM to register a handler to timer events. Additionally or alternatively, a yield service may be provided, which may allow PRM to yield its control to the OS while waiting for a lengthy operation to complete. Additionally or alternatively, an interrupt handler registration service may be provided, which may allow PRM to handle device events. Additionally or alternatively, a multi-processing synchronization service may be provided, e.g., including Mutex (mutually exclusive access) and Semaphore services. These services may allow PRM to provide services to multiple callers in parallel, while protecting critical resources. With these expanded OS services, PRM may be improved to host complex and lengthy functions with same level of flexibility and efficiency as OS drivers.

These expanded OS services may be defined to be OS neutral, so PRM codes can keep its OS independency while using these services. An OS specific translation layer may be provided at runtime to adapt PRM OS service calls into native OS services from Linux or Windows.

FIG. 2 shows a schematic diagram of an example of a PRM Architecture with a PRM Handler using the afore-mentioned expanded OS services. FIG. 2 shows a first block 210 with an OS driver 212 and APCI methods (such as _DSM, Device-Specific Methods) 214). The first block addresses legacy usage models based on _DSM invocation. The OS driver invokes the ACPI methods via ACPI. In contrast to other cases, SMI is not being used. The ACPI methods access PRM Bridge Driver 10 (e.g., the BIOS apparatus or device) via the PRM OpRegion. A second (direct invocation) block 220 also includes an OS driver and access the PRM Bridge Driver 10. The PRM Bridge Driver 10 operates via PRM handlers 240, which are used in lieu of SMI handlers. OS kernel services 230 (such as Yield, Timer, Interrupt, MP sync) also interact with the PRM handlers 240.

As depicted in FIG. 2, the PRM Bridge Driver 10 at the center passes direct invocations or indirect invocations (via ACPI) from OS drivers to OS agnostic PRM Handlers 240 (where PRM Handlers can also be called PRM Modules as they may be independently installable and updatable). A PRM Handler 240 performs its tasks in close interaction with OS kernel 230 through the OS services.

In the following, some use cases are presented that build upon the proposed concept.

As a first use case, a new system function is abstracted as an instruction. The example is “PCommit”. PCommit flushes data from DDR (Double Data Rate) RAM (Random Access Memory) to persistent memory (such as Intel 3D XPoint™). PCommit was first introduced in the form of a new instruction. (Later on, a new form of PCommit invocation is introduced, to be described in a subsequent section).

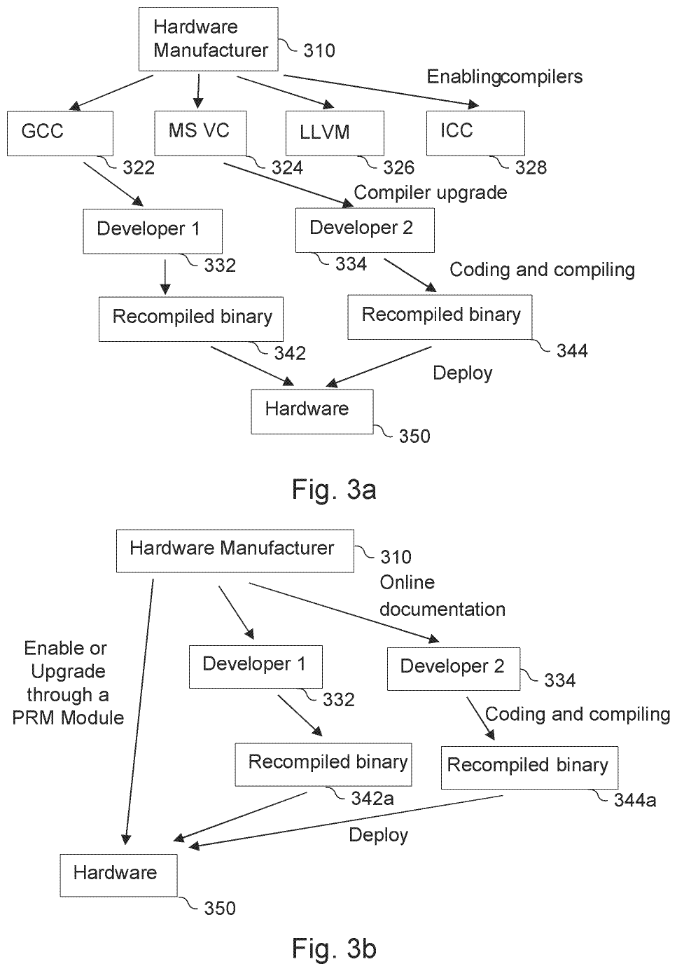

For a new functionality to be represented as an instruction, the conventional software enabling process is shown in FIG. 3a. FIG. 3a shows an example of a process for enabling a new instruction. In the process, the hardware manufacturer 310 enables upgrades to popular compilers, such as GCC 322, MSVC 324, LLVM 326 or ICC 328. The four compilers are maintained by four different entities or companies, such that at least three of them may be externally maintained with respect to the hardware manufacturer. The software developers 332; 334 may upgrade the compiler tool, check out the manual about the syntax of the new instruction, and build applications that make use of the new or updated function (e.g., PCommit). As result, the developers provide recompiled binaries 342; 344, which are deployed on the hardware 350.

In the proposed concept, an enhanced process is provided. FIG. 3b shows an example of an enhanced process for enabling a new instruction. As shown in FIG. 3b, using the enhanced PRM design in the proposed concept, a more efficient enabling process may comprise the hardware manufacturer 310 releasing a PRM module that encapsulate the new or updated instruction (e.g., PCommit). BIOS vendors or OEM nay integrate the PRM module, and the platform ships with the BIOS comprising the integrated PRM module. The software developers 332; 334 may check the website of the hardware manufacturer and find the new PRM module that has the new feature. The software developers 332; 334 may write code that retrieves this PRM module and makes use of it through well-defined PRM enumeration and invoking APIs, leading to recompiled binaries 342a; 344a, which are deployed to the hardware. In this enhanced process, no compiler upgrade may be required. The software enabling work may be limited to within the BIOS and may mostly be done by the hardware manufacturer, such that efforts are not multiplied and distributed across the various ecosystems. Moreover, the application software developers can use new features with an existing version of the compiler.

It is worth noting that in the first use case, it may be more time consuming to call a PRM service than to run a pre-compiled instruction embedded in the program. So the first use-case might only be feasible to cases where a new feature does not need frequent or consecutive invocations. For example, AVX instructions might not be enhanced by this process since they are more efficient in compiled form; however, system functions such as flushing cache to persistent memory may benefit from this enhanced process.

In a second use case, a new system function is invoked through hardware programming. Again, PCommit is used as an example. PCommit's second form of invocation may require software to write to a specific (system reserved) memory addresses. This form of invocation enhances the first form in that it does not define a new instruction (hence no need of compiler upgrade), but it may require hardware programming.

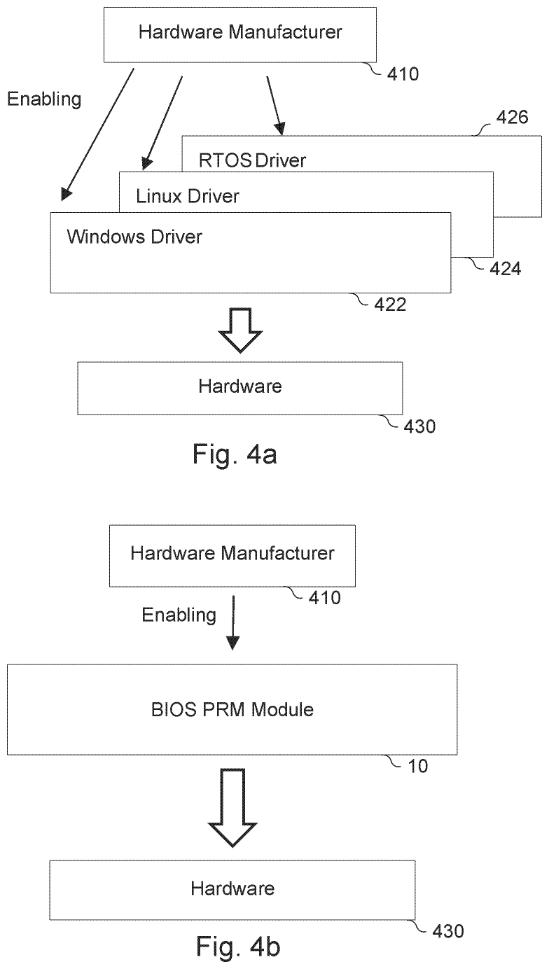

FIG. 4a shows a schematic diagram of a process for enabling a new system function. In the process, the abstraction of this system function may be provided through an OS device driver (e.g., Windows driver 422, Linux driver 424 or Real-Time Operating System (RTOS) driver 426), which shields upper layer software from the details of the hardware programming requirements (of hardware 430). Evolution of the hardware programming per silicon design changes may also be hidden. Thus, duplicate work may be necessary, by the hardware manufacturer 410, for each OS type and OS version that needs to be enabled.

FIG. 4b shows a schematic diagram of an enhanced process for enabling a new system function. With the usage of PRM, the system function may be abstracted through a PRM interface, where the PRM module 10 implementing this interface may be directly deployable in multiple OS versions and types, eliminating the duplicated work for each OS type and version.

A third use case relates to online compilation. New features that need frequent or consecutive invocations, such as new instructions used to compose an algorithm or to perform a math function, cannot benefit from using a PRM service for accessing these individual instructions.

For these new instructions, the abstraction may be provided at an architecture independent binary code level. One example of the architecture independent binary intermediate languages is SPIR-V (Standard Portable Intermediate Representation 5). An online compiler may translate the binary intermediate language into device code at runtime, where device codes and their deployments can vary in different hardware models and generations.

FIG. 5a shows a schematic diagram of an example of a process for enabling new graphics hardware. With the software enabling flow, an OS specific device driver (e.g., Windows driver 522, Linux driver 524 or RTOS driver 526) may host the online compilation 530 and deployment of device codes (based on the intermediate binary codes 540) into the actual hardware (e.g., the discrete graphics card 554). For example, the driver and compiler may run on the host CPU 552. This approach may eliminate the need of a compiler upgrade at the application developer side for any hardware enhancement. However, for new hardware, this approach still needs a device driver to be updated (by the hardware manufacturer 510) and deployed for each OS type and version.

FIG. 5b shows a schematic diagram of an example of an enhanced process for enabling new graphics hardware. By using the proposed concept described in the present disclosure, the online compiler and device code deployments may be hosted by a PRM module 10 (which may be implemented by the BIOS apparatus or device 10). Whenever there is a device code or hardware design change, the only update needed might be on the PRM module which can be released as part of firmware update (e.g. a seamless update) for targeted platforms. No additional development or validation efforts to support multiple OS types and versions might be necessary.

The proposed concept may simplify software enabling for hardware features by avoiding duplicated work for OS types and versions. The proposed concept may reduce both development costs and sustaining costs. Time-to-market may be shortened because of reduced development costs. Client, server, and IoT (Internet of Things) products can benefit from the proposed concept. The proposed concept may expedite hardware manufacturer's delivery of new hardware features through a simplified software enabling infrastructure.

The aspects and features described in relation to a particular one of the previous examples may also be combined with one or more of the further examples to replace an identical or similar feature of that further example or to additionally introduce the features into the further example.

In the following, some examples are presented:

An example (e.g., example 1) relates to a firmware apparatus (10) for a computer system (100), the computer system comprising processing circuitry (105), the firmware apparatus comprising an interface (12) for accessing functionality of the firmware apparatus from an operating system of the computer system. The firmware apparatus (10) comprises control circuitry (14), configured to identify one or more processing functionalities being supported by the processing circuitry of the computer system, provide information on the one or more processing functionalities via the interface to a user mode interface of the operating system of the computer system, and provide access to the one or more processing functionalities for application programs being executed in the operation system, the access being based on the information on the one or more processing functionalities provided to the user mode interface.

Another example (e.g., example 2) relates to a previously described example (e.g., example 1) or to any of the examples described herein, further comprising that the control circuitry is configured to host a driver for accessing the one or more processing functionalities.

Another example (e.g., example 3) relates to a previously described example (e.g., one of the examples 1 to 2) or to any of the examples described herein, further comprising that the control circuitry is configured to provide access to the one or more processing functionalities via one or more advanced configuration and power interface methods exposed towards the operating system.

Another example (e.g., example 4) relates to a previously described example (e.g., one of the examples 1 to 3) or to any of the examples described herein, further comprising that the access to the one or more processing functionalities is provided via a processing functionality-agnostic driver hosted by the operating system.

Another example (e.g., example 5) relates to a previously described example (e.g., one of the examples 1 to 4) or to any of the examples described herein, further comprising that the control circuitry is configured to yield control to the operating system while waiting for the execution of a processing functionality to complete.

Another example (e.g., example 6) relates to a previously described example (e.g., one of the examples 1 to 5) or to any of the examples described herein, further comprising that the control circuitry is configured to expose one or more services towards the operating system via the interface.

Another example (e.g., example 7) relates to a previously described example (e.g., example 6) or to any of the examples described herein, further comprising that the control circuitry is configured to expose at least one handler for timer events towards the operating system, wherein the at least one handler for timer events set to trigger at least one processing functionality.

Another example (e.g., example 8) relates to a previously described example (e.g., one of the examples 6 to 7) or to any of the examples described herein, further comprising that the control circuitry is configured to expose at least one interrupt handler towards the operating system, wherein the at least interrupt handler is set to trigger at least one processing functionality.

Another example (e.g., example 9) relates to a previously described example (e.g., one of the examples 6 to 8) or to any of the examples described herein, further comprising that the control circuitry is configured to expose at least one service for multi-processing synchronization to the operating system.

Another example (e.g., example 10) relates to a previously described example (e.g., example 9) or to any of the examples described herein, further comprising that the control circuitry is configured to expose at least one service for handling mutually exclusive access to the one or more processing functionalities to the operating system.

Another example (e.g., example 11) relates to a previously described example (e.g., one of the examples 9 to 10) or to any of the examples described herein, further comprising that the control circuitry is configured to expose at least one semaphore service for synchronizing access to the one or more processing functionalities to the operating system.

Another example (e.g., example 12) relates to a previously described example (e.g., example 11) or to any of the examples described herein, further comprising that the one or more services are implemented in an operating system-agnostic manner, wherein the control circuitry is configured to provide an operating system-specific translation functionality to translate native operating system-specific service calls to operating system-agnostic service calls.

Another example (e.g., example 13) relates to a previously described example (e.g., one of the examples 1 to 12) or to any of the examples described herein, further comprising that the control circuitry is configured to perform online compilation of a device-independent intermediate binary code of the application programs to device-specific code for accessing the one or more processing functionalities.

Another example (e.g., example 14) relates to a previously described example (e.g., one of the examples 1 to 13) or to any of the examples described herein, further comprising that the processing circuitry comprises one or more central processing units and/or one or more graphics processing units.

Another example (e.g., example 15) relates to a previously described example (e.g., one of the examples 1 to 14) or to any of the examples described herein, further comprising that the firmware apparatus is implemented as component of a basic input output system or unified extensible firmware interface of the computer system.

An example (e.g., example 16) relates to a computer system (100) comprising the firmware apparatus (10) according to one of the examples 1 to 15 or according to any other example.

Another example (e.g., example 17) relates to a previously described example (e.g., example 16) or to any of the examples described herein, further comprising that the user mode interface is provided to the application programs in user mode.

Another example (e.g., example 18) relates to a previously described example (e.g., one of the examples 16 to 17) or to any of the examples described herein, further comprising that the user mode interface is implemented as a library that is accessible to the application programs in user space.

An example (e.g., example 19) relates to a firmware device (10) for a computer system (100), the computer system comprising processing circuitry (105), the firmware device comprising means for communicating (12), suitable for accessing functionality of the firmware device from an operating system of the computer system. The firmware device (10) comprises means for controlling (14), configured to identify one or more processing functionalities being supported by the processing circuitry of the computer system, provide information on the one or more processing functionalities via the means for communicating to a user mode interface of the operating system of the computer system, and provide access to the one or more processing functionalities for application programs being executed in the operation system, the access being based on the information on the one or more processing functionalities provided to the user mode interface.

Another example (e.g., example 20) relates to a previously described example (e.g., example 19) or to any of the examples described herein, further comprising that the means for controlling is configured to host a driver for accessing the one or more processing functionalities.

Another example (e.g., example 21) relates to a previously described example (e.g., one of the examples 19 to 20) or to any of the examples described herein, further comprising that the means for controlling is configured to provide access to the one or more processing functionalities via one or more advanced configuration and power interface methods exposed towards the operating system.

Another example (e.g., example 22) relates to a previously described example (e.g., one of the examples 19 to 21) or to any of the examples described herein, further comprising that the access to the one or more processing functionalities is provided via a processing functionality-agnostic driver hosted by the operating system.

Another example (e.g., example 23) relates to a previously described example (e.g., one of the examples 19 to 22) or to any of the examples described herein, further comprising that the means for controlling is configured to yield control to the operating system while waiting for the execution of a processing functionality to complete.

Another example (e.g., example 24) relates to a previously described example (e.g., one of the examples 19 to 23) or to any of the examples described herein, further comprising that the means for controlling is configured to expose one or more services towards the operating system via the means for communicating.

Another example (e.g., example 25) relates to a previously described example (e.g., example 24) or to any of the examples described herein, further comprising that the means for controlling is configured to expose at least one handler for timer events towards the operating system, wherein the at least one handler for timer events set to trigger at least one processing functionality.

Another example (e.g., example 26) relates to a previously described example (e.g., one of the examples 24 to 25) or to any of the examples described herein, further comprising that the means for controlling is configured to expose at least one interrupt handler towards the operating system, wherein the at least interrupt handler is set to trigger at least one processing functionality.

Another example (e.g., example 27) relates to a previously described example (e.g., one of the examples 24 to 26) or to any of the examples described herein, further comprising that the means for controlling is configured to expose at least one service for multi-processing synchronization to the operating system.

Another example (e.g., example 28) relates to a previously described example (e.g., example 27) or to any of the examples described herein, further comprising that the means for controlling is configured to expose at least one service for handling mutually exclusive access to the one or more processing functionalities to the operating system.

Another example (e.g., example 29) relates to a previously described example (e.g., one of the examples 27 to 28) or to any of the examples described herein, further comprising that the means for controlling is configured to expose at least one semaphore service for synchronizing access to the one or more processing functionalities to the operating system.

Another example (e.g., example 30) relates to a previously described example (e.g., example 11) or to any of the examples described herein, further comprising that the one or more services are implemented in an operating system-agnostic manner, wherein the means for controlling is configured to provide an operating system-specific translation functionality to translate native operating system-specific service calls to operating system-agnostic service calls.

Another example (e.g., example 31) relates to a previously described example (e.g., one of the examples 19 to 30) or to any of the examples described herein, further comprising that the means for controlling is configured to perform online compilation of a device-independent intermediate binary code of the application programs to device-specific code for accessing the one or more processing functionalities.

Another example (e.g., example 32) relates to a previously described example (e.g., one of the examples 19 to 31) or to any of the examples described herein, further comprising that the processing circuitry comprises one or more central processing units and/or one or more graphics processing units.

Another example (e.g., example 33) relates to a previously described example (e.g., one of the examples 19 to 32) or to any of the examples described herein, further comprising that the firmware device is implemented as component of a basic input output system or unified extensible firmware interface of the computer system.

An example (e.g., example 34) relates to a computer system (100) comprising the firmware device (10) according to one of the examples 19 to 33 or according to any other example.

Another example (e.g., example 35) relates to a previously described example (e.g., example 34) or to any of the examples described herein, further comprising that the user mode interface is provided to the application programs in user mode.

Another example (e.g., example 36) relates to a previously described example (e.g., one of the examples 34 to 35) or to any of the examples described herein, further comprising that the user mode interface is implemented as a library that is accessible to the application programs in user space.

An example (e.g., example 37) relates to a firmware method for a firmware (10) of the computer system (100), the computer system comprising processing circuitry (105), the firmware method comprising identifying (110) one or more processing functionalities being supported by the processing circuitry of the computer system. The firmware method comprises providing (120) information on the one or more processing functionalities via an interface for accessing functionality of the firmware from an operating system of the computer system to a user mode interface of the operating system of the computer system. The firmware method comprises providing (140) access to the one or more processing functionalities for application programs being executed in the operation system, the access being based on the information on the one or more processing functionalities provided to the user mode interface.

Another example (e.g., example 38) relates to a previously described example (e.g., example 37) or to any of the examples described herein, further comprising that the method comprises hosting (142) a driver for accessing the one or more processing functionalities.

Another example (e.g., example 39) relates to a previously described example (e.g., one of the examples 37 to 38) or to any of the examples described herein, further comprising that the method comprises providing the access (140) to the one or more processing functionalities via one or more advanced configuration and power interface methods exposed towards the operating system.

Another example (e.g., example 40) relates to a previously described example (e.g., one of the examples 37 to 39) or to any of the examples described herein, further comprising that the access to the one or more processing functionalities is provided via a processing functionality-agnostic driver hosted by the operating system.

Another example (e.g., example 41) relates to a previously described example (e.g., one of the examples 37 to 40) or to any of the examples described herein, further comprising that the method comprises yielding (144) control to the operating system while waiting for the execution of a processing functionality to complete.

Another example (e.g., example 42) relates to a previously described example (e.g., one of the examples 37 to 41) or to any of the examples described herein, further comprising that the method comprises exposing (130) one or more services towards the operating system via the interface.

Another example (e.g., example 43) relates to a previously described example (e.g., example 42) or to any of the examples described herein, further comprising that the method comprises exposing (132) at least one handler for timer events towards the operating system, wherein the at least one handler for timer events set to trigger at least one processing functionality.

Another example (e.g., example 44) relates to a previously described example (e.g., one of the examples 42 to 43) or to any of the examples described herein, further comprising that the method comprises exposing (134) at least one interrupt handler towards the operating system, wherein the at least interrupt handler is set to trigger at least one processing functionality.

Another example (e.g., example 45) relates to a previously described example (e.g., one of the examples 42 to 44) or to any of the examples described herein, further comprising that the method comprises exposing (136) at least one service for multi-processing synchronization to the operating system.

Another example (e.g., example 46) relates to a previously described example (e.g., example 45) or to any of the examples described herein, further comprising that the method comprises exposing (136a) at least one service for handling mutually exclusive access to the one or more processing functionalities to the operating system.

Another example (e.g., example 47) relates to a previously described example (e.g., one of the examples 45 to 46) or to any of the examples described herein, further comprising that the method comprises exposing (136b) at least one semaphore service for synchronizing access to the one or more processing functionalities to the operating system.

Another example (e.g., example 48) relates to a previously described example (e.g., example 47) or to any of the examples described herein, further comprising that the one or more services are implemented in an operating system-agnostic manner, wherein the method comprises providing (146) an operating system-specific translation functionality to translate native operating system-specific service calls to operating system-agnostic service calls.

Another example (e.g., example 49) relates to a previously described example (e.g., one of the examples 37 to 48) or to any of the examples described herein, further comprising that the method comprises performing (148) online compilation of a device-independent intermediate binary code of the application programs to device-specific code for accessing the one or more processing functionalities.

Another example (e.g., example 50) relates to a previously described example (e.g., one of the examples 37 to 49) or to any of the examples described herein, further comprising that the processing circuitry comprises one or more central processing units and/or one or more graphics processing units.

Another example (e.g., example 51) relates to a previously described example (e.g., one of the examples 37 to 50) or to any of the examples described herein, further comprising that the firmware method is performed by a basic input output system or unified extensible firmware interface of the computer system.

An example (e.g., example 52) relates to a computer system (100) being configured to perform the firmware method according to one of the examples 37 to 51 or according to any other example described herein.

Another example (e.g., example 53) relates to a previously described example (e.g., example 52) or to any of the examples described herein, further comprising that the user mode interface is provided to the application programs in user mode.

Another example (e.g., example 54) relates to a previously described example (e.g., one of the examples 52 to 53) or to any of the examples described herein, further comprising that the user mode interface is implemented as a library that is accessible to the application programs in user space.

An example (e.g., example 55) relates to a machine-readable storage medium including program code, when executed, to cause a machine to perform the method of one of the examples 37 to 51 or according to any previous example.

An example (e.g., example 56) relates to a computer program having a program code for performing the method of one of the examples 37 to 51 or according to any previous example, when the computer program is executed on a computer, a processor, or a programmable hardware component.

An example (e.g., example 57) relates to a machine-readable storage including machine readable instructions, when executed, to implement a method or realize an apparatus as claimed in any pending claim or shown in any example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A firmware apparatus for a computer system, the computer system comprising processing circuitry (105), the firmware apparatus comprising:
an interface for accessing functionality of the firmware apparatus from an operating system of the computer system; and
control circuitry to:
identify one or more processing functionalities being supported by the processing circuitry of the computer system,
provide information on the one or more processing functionalities via the interface to a user mode interface of the operating system of the computer system, and
provide access to the one or more processing functionalities for application programs being executed in the operation system, the access being based on the information on the one or more processing functionalities provided to the user mode interface.

2. The firmware apparatus according to claim 1, wherein the control circuitry is to host a driver for accessing the one or more processing functionalities.

3. The firmware apparatus according to claim 1, wherein the control circuitry is to provide access to the one or more processing functionalities via one or more advanced configuration and power interface methods exposed towards the operating system.

4. The firmware apparatus according to claim 1, wherein the access to the one or more processing functionalities is provided via a processing functionality-agnostic driver hosted by the operating system.

5. The firmware apparatus according to claim 1, wherein the control circuitry is to yield control to the operating system while waiting for the execution of a processing functionality to complete.

6. The firmware apparatus according to claim 1, wherein the control circuitry is to expose one or more services towards the operating system via the interface.

7. The firmware apparatus according to claim 6, wherein the control circuitry is to expose at least one handler for timer events towards the operating system, wherein the at least one handler for timer events set to trigger at least one processing functionality.

8. The firmware apparatus according to claim 6, wherein the control circuitry is to expose at least one interrupt handler towards the operating system, wherein the at least interrupt handler is set to trigger at least one processing functionality.

9. The firmware apparatus according to claim 6, wherein the control circuitry is to expose at least one service for multi-processing synchronization to the operating system.

10. The firmware apparatus according to claim 9, wherein the control circuitry is to expose at least one service for handling mutually exclusive access to the one or more processing functionalities to the operating system.

11. The firmware apparatus according to claim 9, wherein the control circuitry is to expose at least one semaphore service for synchronizing access to the one or more processing functionalities to the operating system.

12. The firmware apparatus according to claim 11, wherein the one or more services are implemented in an operating system-agnostic manner, wherein the control circuitry is to provide an operating system-specific translation functionality to translate native operating system-specific service calls to operating system-agnostic service calls.

13. The firmware apparatus according to claim 1, wherein the control circuitry is to perform online compilation of a device-independent intermediate binary code of the application programs to device-specific code for accessing the one or more processing functionalities.

14. The firmware apparatus according to claim 1, wherein the processing circuitry comprises one or more central processing units and/or one or more graphics processing units.

15. The firmware apparatus according to claim 1, wherein the firmware apparatus is implemented as component of a basic input output system or unified extensible firmware interface of the computer system.

16. A computer system comprising the firmware apparatus according to claim 1.

17. The computer system according to claim 16, wherein the user mode interface is provided to the application programs in user mode.

18. The computer system according to claim 16, wherein the user mode interface is implemented as a library that is accessible to the application programs in user space.

19-20. (canceled)

21. A firmware method for a firmware of the computer system, the computer system comprising processing circuitry, the firmware method comprising:
identifying one or more processing functionalities being supported by the processing circuitry of the computer system;
providing information on the one or more processing functionalities via an interface for accessing functionality of the firmware from an operating system of the computer system to a user mode interface of the operating system of the computer system; and
providing access to the one or more processing functionalities for application programs being executed in the operation system, the access being based on the information on the one or more processing functionalities provided to the user mode interface.

22-23. (canceled)

24. A machine-readable storage medium including program code, when executed, to cause a machine to perform the method of claim 19.
